(19) United States
(12) Patent Application Publication
(10) Pub. No.: US 2013/0287299 A1
(43) Pub. Date: Oct. 31, 2013

(54) IMAGE PROCESSING APPARATUS

(71) Applicant: National Taipei University of Technology, Taipei (TW)

(72) Inventors: Shih-Chia Huang, Taipei (TW); Bo-Hao Chen, Taipei (TW)

(21) Appl. No.: 13/925,852

(22) Filed: Jun. 25, 2013

Related U.S. Application Data
(63) Continuation-in-part of application No. 13/276,823, filed on Oct. 19, 2011.

(30) Foreign Application Priority Data
Aug. 10, 2011 (TW) 100128472

(51) Int. Cl. G06T 9/00

(52) U.S. Cl. CPC G06T 9/00
USPC 382/169

(57) ABSTRACT

The invention discloses an image processing apparatus. The image processing apparatus includes an image statistic computation circuitry, a reconfigurable circuitry and a luminance transformation circuitry. The image statistic computation circuitry computes a probability density function corresponding to an inputted image; generates a first luminance histogram by subsampling a luminance histogram related to the probability density function in a first period. The reconfigurable circuitry computes a weighting distribution function according to the first luminance histogram in a second period after the first period; computes a smoothed cumulative density function according to the weighting distribution function in a third period after the second period; computes a gamma transform function in a fourth period after the third period. The luminance transformation circuitry generates a resulted image by adjusting a luminance distribution of the inputted image based on the gamma transform function in a fifth period after the fourth period.

### CROSS-REFERENCE TO RELATED APPLICATION

This application is a continuation-in-part of and claims the priority benefit of U.S. application Ser. No. 13/276,823, filed on Oct. 19, 2011, now pending. The prior application Ser. No. 13/276,823 claims the priority benefit of Taiwan application serial no. 100128472, filed on Aug. 10, 2011. The entirety of the above-mentioned patent applications is hereby incorporated by reference herein and made a part of this specification.

### BACKGROUND

1. Field of the Invention

The invention relates to a processing apparatus, in particular, to an image processing apparatus.

2. Description of Related Art

Contrast enhancement plays an important role in the improvement of visual quality for computer vision, pattern recognition, and the processing of digital images.

Generally, traditional histogram equalization (THE) can be used to enhance the image contrast by using probability density function (PDF). However, the above method uses the entirety of the information of the histogram, so it is impossible to maintain the brightness of the original image.

To solve the shortcoming of the traditional histogram equalization, variable methods which based on the traditional histogram equalization are proposed to maintain the brightness of the primary image. Most of these methods are accomplished by histogram segmentation. Nevertheless, these methods are prone to produce distortions of the local features.

Typically, a conventional gamma correction method may rapidly enhance image contrast by adjusting the gamma variables in the function. However, gamma correction cannot provide dynamic adjustment of image contrast enhance to every dimmed image. In order to solve the shortcoming, a method called dynamic contrast ratio gamma correction (DCRGC) combines histogram normalization and reverse-gamma correction is proposed to cope with the dynamic contrast enhancement problem. Unfortunately, this method still cannot automatically obtain contrast enhancement from variable controls.

### SUMMARY

Accordingly, the present invention is directed to an image processing apparatus, which could achieve a high image processing efficiency.

An image processing apparatus is introduced herein. The image processing apparatus includes an image statistic computation circuitry, a reconfigurable circuitry and a luminance transformation circuitry. The image statistic computation circuitry is configured to: compute a probability density function corresponding to an inputted image; generate a first luminance histogram by subsampling a luminance histogram related to the probability density function in a first period. The reconfigurable circuitry is coupled to the image statistic computation circuitry and configured to: compute a weighting distribution function according to the first luminance histogram in a second period after the first period; compute a smoothed cumulative density function according to the weighting distribution function in a third period after the second period; compute a gamma transform function in a fourth period after the third period, wherein the gamma transform function is related to the smoothed cumulative density function.

The luminance transformation circuitry is coupled to the reconfigurable circuitry and configured to generate a resulted image by adjusting a luminance distribution of the inputted image based on the gamma transform function in a fifth period after the fourth period.

In one embodiment of the present invention, the reconfigurable circuitry computes the weighting distribution function by:

PDF′_{ω}(l)=max(PDF′)×2^{β},

where β=α{log₂[PDF′(l)−min(PDF′)]−log₂[max(PDF′)−min(PDF′)]}, wherein l is a luminance of one of locations of the inputted image, PDF′_{ω}(PDF′) is the weighting distribution function, PDF′(l) is the probability density function, max(PDF′) is a maximum probability density of the probability density function, min(PDF′) is a minimum probability density of the probability density function, and α is an adaptive parameter.

In one embodiment of the present invention, the reconfigurable circuitry computes the weighting distribution function by:

$${CDF}_{s}^{′} ( l ) = {2}^{( {log}_{2} ( {Σ}_{l = {l}_{min}}^{{l}_{max}} {{PDF}_{ω}^{′} ( l )}^{′} ) - {log}_{2} ( Σ {PDF}_{ω}^{′} ) )} ,$$

where l is a luminance of one of locations of the inputted image, CDF′ₛ(l) is the smoothed cumulative density function, PDF′_{ω}(l) is the weighting distribution function, ΣPDF′_{w} is a sum of weighting probabilities, lₘₐₓ is a maximum luminance of the inputted image, and lₘᵢₙ is a minimum luminance of the inputted image.

In one embodiment of the present invention, the reconfigurable circuitry computes the gamma transform function by:

T(l)=(lₘₐₓ−lₘᵢₙ)×2^{γ(log}^{₂}^{l-log}^{₂}^{(l}^{ₘₐₓ}^{-l}^{ₘᵢₙ}⁾⁾,

where l is a luminance of one of locations of the inputted image, T(l) is the gamma transform function, lₘₐₓ is a maximum luminance of the inputted image and lₘᵢₙ is a minimum luminance of the inputted image, wherein γ is represented by:

γ=1−CDF′ₛ(l)×P,

where CDF′ₛ(l) is the weighting distribution function and P is an adaptive parameter.

In one embodiment of the present invention, the reconfigurable circuitry includes a logarithmic calculation unit, a delay unit, a subtraction unit, a first multiplication unit, an exponent calculation unit and a second multiplication unit. The logarithmic calculation unit is configured to: generate a first value by performing a logarithmic calculating operation to a first input signal at a first timing point of a specific period; generate a second value by performing the logarithmic calculating operation to a second input signal at a second timing point of the specific period. The delay unit is coupled to the logarithmic calculation unit and configured to receive the first value and generate a delayed first value by delaying the first value. The subtraction unit is coupled to the logarithmic calculation unit and the delay unit and configured to subtract the second value from the first value to generate a third value after receiving the first value and the second value. The first multiplication unit is coupled to the subtraction unit and configured to multiply the third value with a first specific parameter to generate a fourth value. The exponent calculation unit is coupled to the first multiplication unit and configured to generate a fifth value by performing an exponent calculating operation to the fourth value. The second multiplication unit is coupled to the exponent calculation unit and configured to generate an output value by multiplying the fifth value with a second specific parameter.

In one embodiment of the present invention, when the specific period is the second period, the first input signal is PDF′(l)−min(PDF′), the second input signal is max(PDF′)−min(PDF′), the first specific parameter is an adaptive parameter, the second specific parameter is max(PDF′), and the output value is PDF′(l). l is a luminance of one of locations of the inputted image, PDF is the weighting distribution function, PDF′(l) is the probability density function, max(PDF′) is a maximum probability density of the probability density function and min(PDF′) is a minimum probability density of the probability density function.

In one embodiment of the present invention, when the specific period is the third period, the first input signal is Σₗ₌ₗ_{ₘᵢₙ}^{l}^{ₘₐₓ}PDF′_{ω}(l), the second input signal is ΣPDF′_{w}, the first specific parameter is 1, the second specific parameter is 1, and the output value is CDF′ₛ(l). l is a luminance of one of locations of the inputted image, CDF′ₛ(l) is the smoothed cumulative density function, PDF′_{ω}(l) is the weighting distribution function, ΣPDF′_{w} is a sum of weighting probabilities, lₘₐₓ is a maximum luminance of the inputted image, and lₘᵢₙ is a minimum luminance of the inputted image.

In one embodiment of the present invention, when the specific period is the fourth period, the first input signal is l, the second input signal is lₘₐₓ−lₘᵢₙ, the first specific parameter is γ, the second specific parameter is lₘₐₓ−lₘᵢₙ, and the output value is T(l). l is a luminance of one of locations of the inputted image, T(l) is the gamma transform function, lₘₐₓ is a maximum luminance of the inputted image and lₘᵢₙ is a minimum luminance of the inputted image. γ is represented by:

γ=1−CDF′ₛ(l)×P,

wherein CDF′ₛ(l) is the weighting distribution function and P is an adaptive parameter.

In one embodiment of the present invention, the logarithmic calculation unit includes a first multiplexer, a multiplication unit, a first delay unit, a second multiplexer, an adder, a second delay unit and a switch. The first multiplexer is configured to sequentially output a first parameter and a first result in response to a first switch signal. The multiplication unit is coupled to the first multiplexer and configured to generate a second result by multiplying an input signal with the first parameter or the first result, wherein the input signal is the first input signal or the second input signal. The first delay unit is coupled to the multiplication unit and configured to generate a third result by delaying the second result. The second multiplexer is configured to sequentially output a second parameter, a third parameter and a fourth parameter in response to a second switch signal. The adder is coupled to the first delay unit and the second multiplexer and configured to generate a fourth result by adding the third result with the second parameter, the third parameter or the fourth parameter. The second delay unit is coupled to the adder and the first multiplexer and configured to generate the first result by delaying the fourth result. The switch is coupled to the second delay unit and configured to provide the first result as an output result when the second multiplexer finishes outputting the second parameter, the third parameter and the fourth parameter.

In one embodiment of the present invention, the first parameter is 0.1519, the second parameter is −1.02123, the third parameter is 3 and the fourth parameter is −2.13.

In one embodiment of the present invention, the exponent calculation unit includes a first multiplexer, a multiplication unit, a first delay unit, a second multiplexer, an adder, a second delay unit and a switch. The first multiplexer is configured to sequentially output a first parameter and a first result in response to a first switch signal. The multiplication unit is coupled to the first multiplexer and configured to generate a second result by multiplying an input signal with the first parameter or the first result, wherein the input signal is the first input signal or the second input signal. The first delay unit is coupled to the multiplication unit and configured to generate a third result by delaying the second result. The second multiplexer is configured to sequentially output a second parameter, a third parameter and a fourth parameter in response to a second switch signal. The adder is coupled to the first delay unit and the second multiplexer and configured to generate a fourth result by adding the third result with the second parameter, the third parameter or the fourth parameter. The second delay unit is coupled to the adder and the first multiplexer and configured to generate the first result by delaying the fourth result. The switch is coupled to the second delay unit and configured to provide the first result as an output result when the second multiplexer finishes outputting the second parameter, the third parameter and the fourth parameter.

In one embodiment of the present invention, the first parameter is 0.079, the second parameter is 0.2242, the third parameter is 0.6967 and the fourth parameter is 0.999.

In one embodiment of the present invention, the resulted image includes a plurality of pixels, and the image processing apparatus further includes an image enhancing circuitry. The image enhancing circuitry is coupled to the luminance transformation circuitry and configured to enhance a definition of a specific pixel of the pixels according to definitions of the pixels neighbouring to the specific pixel.

In one embodiment of the present invention, the image enhancing circuitry is configured to: compute a first image enhancing parameter by:

NPC(i,j)=Y(i,j)+Y(i−1,j)+Y(i,j−1)−Y(i−1,j−1),

where (i,j) is a coordinate of the specific pixel in the resulted image, NPC(i,j) is the first image enhancing parameter, Y(i,j) is the definition of the specific pixel; compute a second image enhancing parameter by:

Sum(i,j)=NPC(i+a,j+a)−NPC(i−b,j+a)−NPC(i+a,j−b)+NPC(i−b,j−b),

where Sum(i,j) is the second image enhancing parameter, a is a first shifting parameter and b is a second shifting parameter; compute a third image enhancing parameter by:

$$Avg ( i , j ) = \frac{Sum ( i , j )}{( 2 \times {Q}_{1} + 1 ) \times 2} ,$$

where Avg(i,j) is the third image enhancing parameter, Q₁ is a first enhancing factor; compute an enhanced definition of the specific pixel by:

Y′(i,j)=Y(i,j)+(1+Q₂)×(Y(i,j)−Avg(i,j)),

where Q₂ is a second enhancing factor.

Based on the above description, the embodiments of the present invention provide an image processing apparatus including a reconfigurable circuitry capable of sequentially compute the weighting distribution function, the smoothed cumulative density function and the gamma transform function with a shared hardware architecture. The proposed image processing apparatus could achieve a high image processing efficiency while providing great image quality, which makes the image processing apparatus more suitable for real-time applications.

In order to make the aforementioned and other features and advantages of the invention comprehensible, several exemplary embodiments accompanied with figures are described in detail below.

### BRIEF DESCRIPTION OF THE DRAWINGS

FIG. 1 is a flow chart of a first embodiment of a method for improving image quality for display device in accordance with the present invention.

FIG. 2 is a flow chart of a second embodiment of a method for improving image quality for display device in accordance with the present invention.

FIG. 3 is a flow chart of a second embodiment of a method for improving image quality for display device in accordance with the present invention.

FIGS. 4 to 7 are diagrams illustrating improve results of contrast according to first embodiments of the present invention, as compared with the related art.

FIG. 8 is a functional block diagram illustrating an image processing apparatus according to an exemplary embodiment of the present invention.

FIG. 9 is a schematic diagram illustrating the hardware design of the reconfigurable circuitry according to an exemplary embodiment of the present invention.

FIG. 10A is a schematic diagram illustrating the reconfigurable circuitry while computing the weighting distribution function in the second period according to an exemplary embodiment of the present invention.

FIG. 10B is a schematic diagram illustrating the reconfigurable circuitry while computing the smoothed cumulative density function in the third period according to an exemplary embodiment of the present invention.

FIG. 10C is a schematic diagram illustrating the reconfigurable circuitry while computing the gamma transform function in the fourth period according to an exemplary embodiment of the present invention.

FIG. 11 is a schematic diagram illustrating a hardware architecture for implementing the logarithmic calculation unit and the exponent calculation unit.

FIG. 12A to FIG. 12D are schematic diagrams illustrating different results corresponding to various pipeline architectures.

### DETAILED DESCRIPTION OF DISCLOSED EMBODIMENTS

In general, cumulative density function (CDF) can be used to enhance pixel intensity, but the image brightness may be distorted. On the other hand, the conventional gamma correction method uses a constant power function with exponent γ for the image enhancement. Therefore, the major challenge is how to automatically determine the parameter γ.

Inspired by the probability and statistical inference, it is possible to determine the parameter γ based on probability density function (PDF) and cumulative density function (CDF). Hence, the equation can be reasonably modified by combining the cumulative density function (CDF) curve. The proposed gamma transformation equation can be defined as follows:

$$T ( l ) = 255 {( \frac{l}{255} )}^{1 - CDF ( l )} \qquad ( 1 )$$

where l=lmin, lmin+1, lmin+2, . . . , lmax. Unfortunately, the CDF curve of the dimmed image experiences significant fluctuations due to environmental situations. As a result, unfavorable artifacts may be generated by equation.

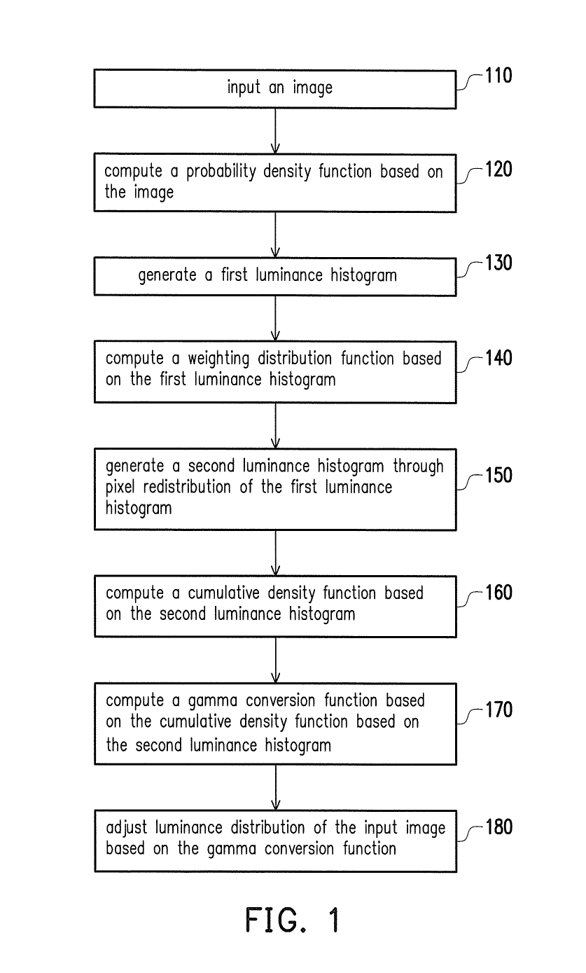

In order to solve these problems, with reference to FIG. 1, a first embodiment of a method for improving image quality in accordance with the present invention comprises a step (110) of inputting an image; a step (120) of computing a probability density function based on the image; a step (130) of generating a first luminance histogram; a step (140) of computing a weighing distribution function based on the first luminance histogram; a step (150) of generating a second luminance histogram through pixel redistribution of the first luminance histogram; a step (160) of computing a cumulative density function based on the second luminance histogram; a step (170) of computing a gamma conversion function based on the cumulative density function based on the second luminance histogram; and a step (180) of adjusting luminance distribution of the input image based on the gamma conversion function.

In the step (110) of inputting an image, the image is a color image and further comprises a step of obtaining a luminance histogram based on the image.

In the steps (120) and (130) of computing a probability density function based on the image, generating a first luminance histogram. The probability density function calculated based on the image and further comprises a step of computing the probability density function based on the luminance histogram. The first luminance histogram generated based on the probability density function.

In the steps (140) and (150) of computing a weighing distribution function based on the first luminance histogram, generating γ-second luminance histogram through pixel redistribution of the first luminance histogram. The present invention uses the weighing distribution function to smooth the fluctuant phenomenon. The weighing distribution function can be expressed as follows:

$$PDF w ( l ) = max ( PDF ) {( \frac{PDF ( l ) - min ( PDF )}{max ( PDF ) - min ( PDF )} )}^{α} \qquad ( 2 )$$

where l=lmin, lmin+1, lmin+2, . . . , lmax. PDFw(l) represents the weighing probability density, max(PDF) represents the maximum probability density, min(PDF) represents the minimum probability density, and α represents the adaptive parameter that can be experimentally set to 0.5.

The second luminance histogram is generated through pixel redistribution of the first luminance histogram.

In the step (160) of computing a cumulative density function based on the second luminance histogram. The original cumulative density function is smoothed and can be expressed as follows:

$$CDFs ( l ) = {\sum }_{h = 0}^{l} \frac{PDF w ( h )}{\sum PDF w} \qquad ( 2 )$$

where l=lmin, lmin+1, lmin+2, . . . , lmax. ΣPDFw represents the sum of the weighing probabilities, and CDFs(l) represents the smoothed cumulative density function.

In the steps (170) and (180) of computing a gamma conversion function based on the cumulative density function based on the second luminance histogram, adjusting luminance distribution of the input image based on the gamma conversion function. The gamma transformation equation can be modified and expressed as the gamma conversion function as follows:

$$T ( l ) = 255 {( \frac{l}{255} )}^{1 - CDFs ( l )} \qquad ( 3 )$$

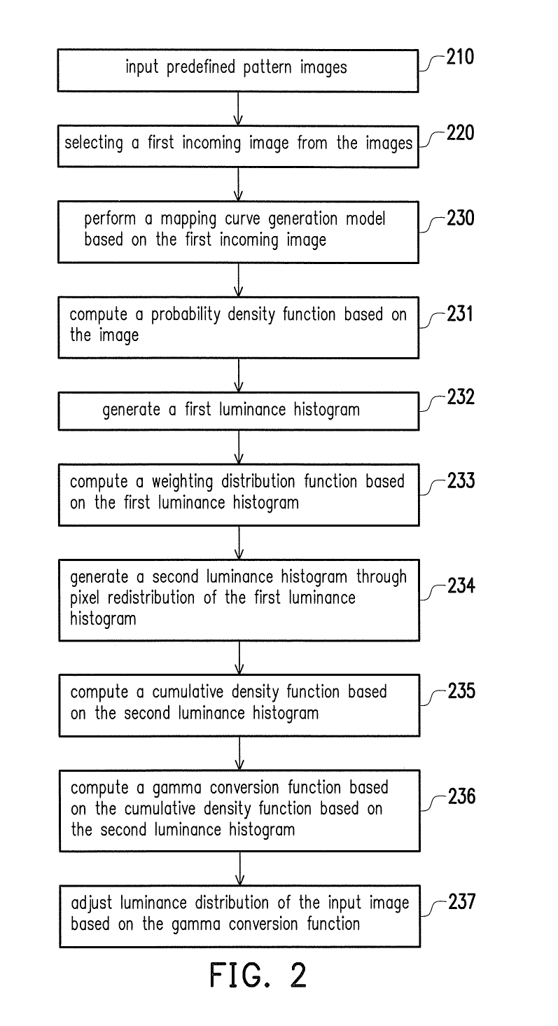

With reference to FIG. 2, a second embodiment of a method for improving image quality for a display device in accordance with the present invention comprises a step (210) of inputting predefined pattern images; a step (220) of selecting a first incoming image from the images; and a step (230) of performing a mapping curve generation model based on the first incoming image.

The step (230) of performing a mapping curve generation model based on the first incoming image comprises a step (231) of computing a probability density function based on the image; a step (232) of generating a first luminance histogram; a step (233) of computing a weighing distribution function based on the first luminance histogram; a step (234) of generating a second luminance histogram through pixel redistribution of the first luminance histogram; a step (235) of computing a cumulative density function based on the second luminance histogram; a step (236) of computing a gamma conversion function based on the cumulative density function based on the second luminance histogram; and a step (237) of adjusting luminance distribution of the input image based on the gamma conversion function.

In the step (210) of inputting predefined pattern images, the predefined pattern images are video images.

In the step (220) of selecting a first incoming image from the images, the first incoming image selected from the first order in the list comprises a step of storing the first incoming image.

In the step (230) of performing a mapping curve generation model based on the first incoming image, the mapping curve generation model performed based on the first incoming image. The mapping curve generation model is the same as the first embodiment of the steps (120) to (180).

For the contrast enhancement of the video sequences, the computational time can be further reduced by using the temporal information between each image. Therefore, the present invention additionally proposes a temporal-based technique to reduce the computational complexity while applying our proposed image enhancement method.

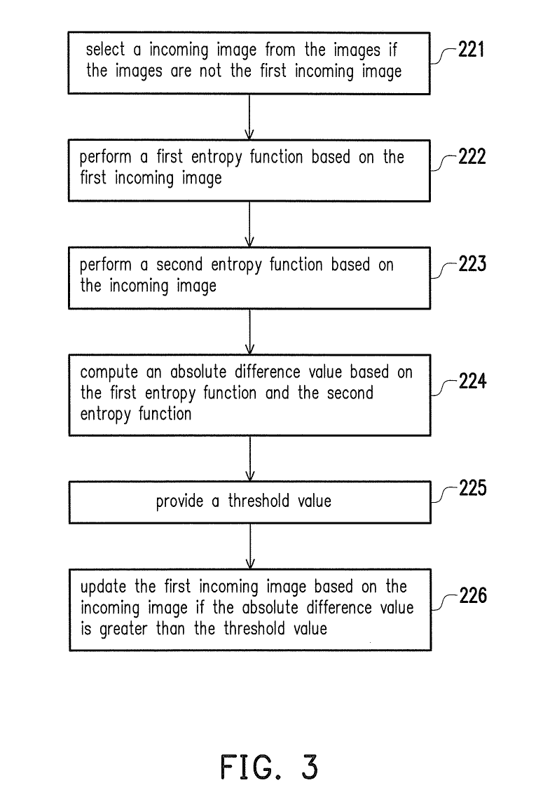

With reference to FIG. 3, in the step (220) of selecting a first incoming image from the images comprises a step (221) of selecting a incoming image from the images if the images are not the first incoming image; a step (222) of performing a first entropy function based on the first incoming image; a step (223) of performing a second entropy function based on the incoming image; a step (224) of computing an absolute difference value based on the first entropy function and the second entropy function; a step (225) of providing a threshold value; and a step (226) of updating the first incoming image based on the incoming image if the absolute difference value is greater than the threshold value.

In the step (221) of if the images are not the first incoming image, selecting a incoming image from the images. The incoming image may be the second, third or fourth, etc. of the images.

In the step (222) of performing a first entropy function based on the first incoming image comprises computing a first probability density function based on the first incoming image; and computing a first entropy function based on the first probability density function. In general, the information content of the first incoming image can be directly quantified by the first entropy function. Based on probability density function, the first entropy function H can be defined as follows:

$$H ( l ) = - {\sum }_{l = 0}^{255} PDF ( l ) {log}_{2} PDF ( l ) \qquad ( 4 )$$

In the step (223) of performing a second entropy function based on the incoming image comprises computing a second probability density function based on the incoming image; and computing a second entropy function based on the second probability density function. The information content of the incoming image can be directly quantified by the second entropy function. Based on probability density function, the second entropy function H can be defined as follows:

$$H ( l ) = - {\sum }_{l = 0}^{255} PDF ( l ) {log}_{2} PDF ( l ) \qquad ( 5 )$$

In the steps (224) and (225) of computing an absolute difference value based on the first entropy function and the second entropy function, providing a threshold value, in order to reduce the computational time, the present invention avoids the re-computation of the mapping curve generation model. According to the first entropy function and the second entropy function, the difference of the information content between the first entropy function and the second entropy function can be estimated through the absolute difference value.

The threshold value is a preset value.

In the step (226) of if the absolute difference value is greater than the threshold value, the first incoming image should be updated by the incoming image, thus the mapping curve generation model should be modified using the incoming frame.

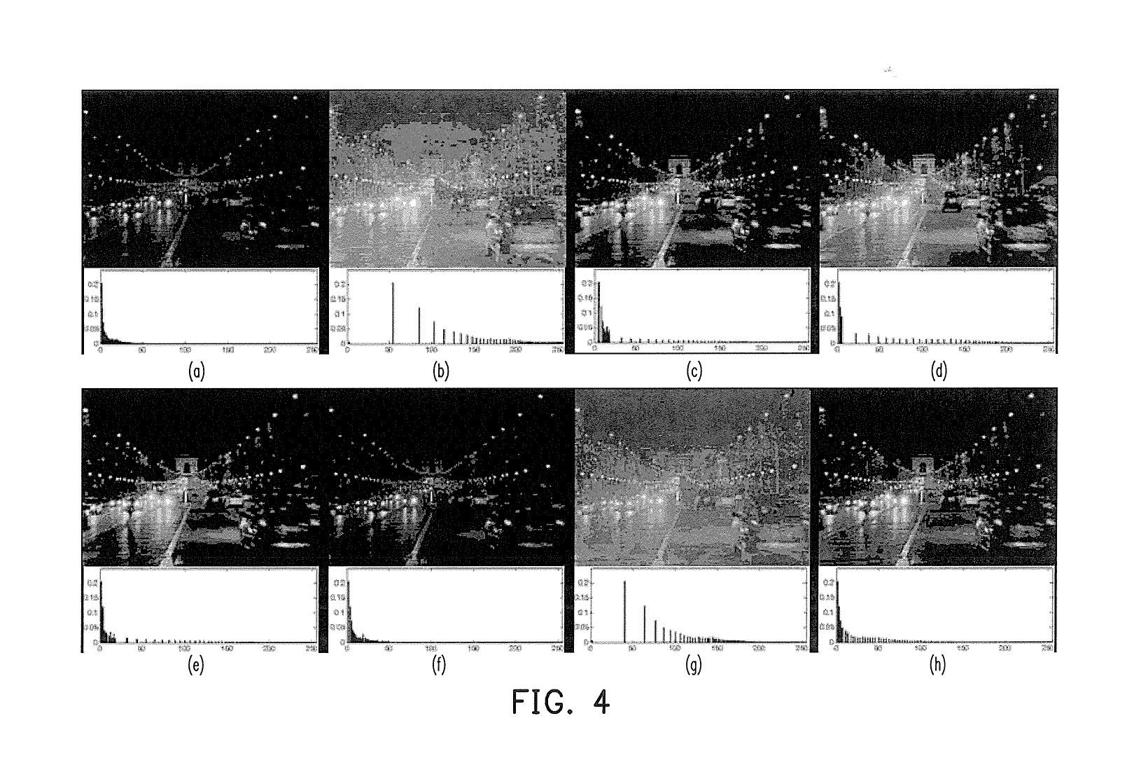

With reference to FIGS. 4 to 6, what shows are diagrams illustrating improve results of contrast according to first embodiments of the present invention, as compared with the related art.

Figures in order: (a) original image; (b) Traditional Histogram Equalization, THE; (c) Brightness Preserving Bi-Histogram Equalization, BBHE; (d) Dualistic Sub-Image Histogram Equalization, DSIHE; (e) Recursive Sub-Image Histogram Equalization, RSIHE; (f) Recursively Separated and Weighted Histogram Equalization, RSWHE; (g) Dynamic Contrast Ratio Gamma Correction, DCRGC; and (h) the first embodiments of the present invention.

This section presents the experimental results for the enhancement of dimmed images. In demonstration of the contribution of this paper, six previous state-of-the-art methods in addition to the proposed method were tested for a variety of natural color images. The test images were broadly obtained in both outdoor and indoor environment.

For outdoor environment, illumination changes may occur in the captured scene due to many factors including the gradual change in the location of the sun, or a sudden switch to dark or cloudy conditions. Conversely, illumination changes presented by indoor environment are relatively simple due to low variation in lighting conditions. In both cases, the details and colors may not be readily discernable to the human eye.

For the input dimmed image, most of the pixels are densely distributed in the low-level region. Based on the weighing distribution function, the fluctuant phenomenon can be smoothened, which reduces the over-enhancement of the gamma correction.

Note that the present invention is the first group to attain color image enhancement through combination of the CDF, the weighing distribution, and the gamma correction. As a result, it is easily observed that the method can enhance the color image with neither generation of additional artifacts nor distortion of color.

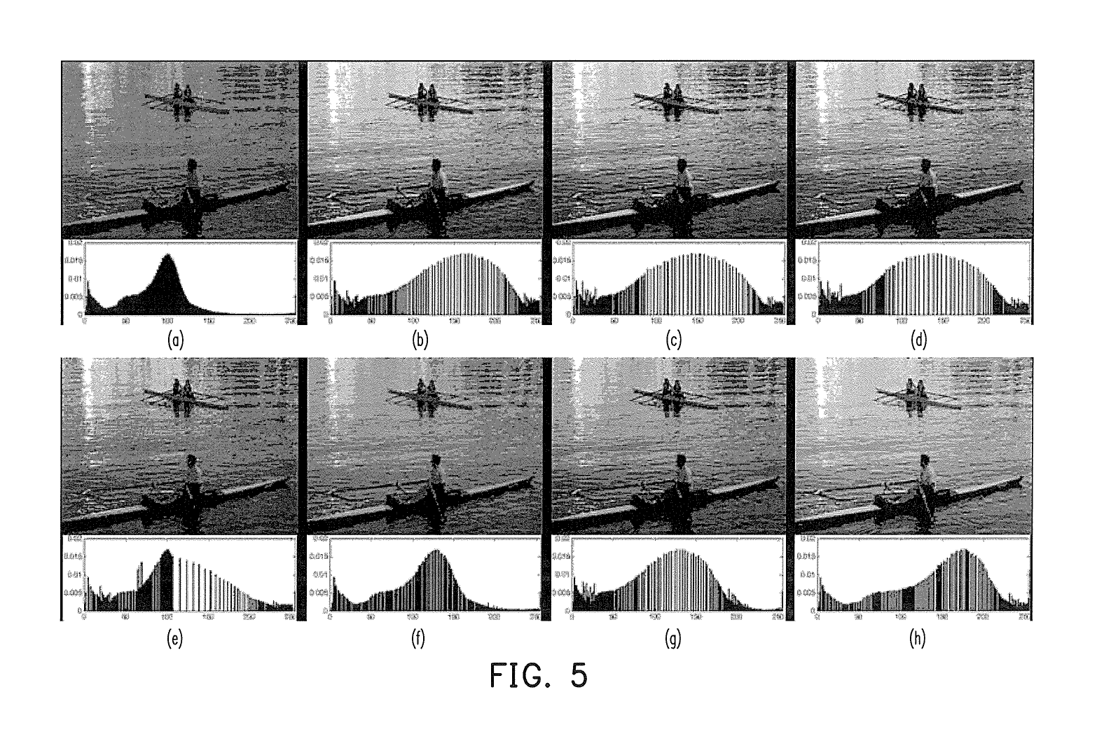

FIG. 8 is a functional block diagram illustrating an image processing apparatus according to an exemplary embodiment of the present invention. In this embodiment, the image processing apparatus 800 includes an image statistic computation circuitry 810, a reconfigurable circuitry 820 and a luminance transformation circuitry 830.

The image statistic computation circuitry 810 could be configured to compute the probability density function corresponding to an inputted image IM. The inputted image IM may be a frame of an image from an image capturing unit, such as a camera. In other embodiments, the inputted image IM may also be a regular image file stored in a storage unit, but the invention is not limited thereto. The image statistic computation circuitry 810 may compute the probability density function by PDF′(l)=nₗ, where nₗ represents the number of pixels for a luminance of one of locations of the inputted image IM. Next, the image statistic computation circuitry 810 may generate a first luminance histogram by subsampling a luminance histogram related to the probability density function (PDF′(l)) in a first period.

To be specific, the image statistic computation circuitry 810 may divide the luminance histogram related to the probability density function (PDF′(l)) through dividing the luminance histogram by 2. As a result, the necessary registers for processing the resulted first luminance histogram could be reduced since the number of bits needed to represent the first luminance histogram is reduced by 1 bit. Furthermore, by subsampling the luminance histogram, the subsequent hardware processing time could be reduced by fifty percent since the gray level distribution of the luminance histogram is correspondingly declined.

The reconfigurable circuitry 820 may be coupled to the image statistic computation circuitry 810 and configured to compute a weighting distribution function according to the first luminance histogram in a second period after the first period.

Specifically, the reconfigurable circuitry 820 may compute the weighting distribution function by:

PDF′_{ω}(l)=max(PDF′)×2^{β} (6),

where β=α{log₂[PDF′(l)−min(PDF′)]−log₂[max(PDF′)−min(PDF′)]}. PDF′_{ω}(l) is the weighting distribution function, max(PDF′) is a maximum probability density of the probability density function, min(PDF′) is a minimum probability density of the probability density function, and α is an adaptive parameter. The adaptive parameter a could be arbitrarily set as any number (e.g., 0.5) according to various design requirements.

In a third period after the second period, the reconfigurable circuitry 820 may compute a smoothed cumulative density function according to the weighting distribution function (i.e., the equation (6)). Specifically, the reconfigurable circuitry 820 may compute the smoothed cumulative density function by:

$${CDF}_{s}^{′} ( l ) = {2}^{( {log}_{2} ( {Σ}_{l = {l}_{min}}^{{l}_{max}} {{PDF}_{ω}^{′} ( l )}^{′} ) - {log}_{2} ( Σ {PDF}_{ω}^{′} ) )} , \qquad ( 7 )$$

where CDF′ₛ(0 is the smoothed cumulative density function, ΣPDF′_{w} is a sum of weighting probabilities, lₘₐₓ is a maximum luminance of the inputted image, and lₘᵢₙ is a minimum luminance of the inputted image IM.

In a fourth period after the third period, the reconfigurable circuitry 820 may compute a gamma transform function related to the smoothed cumulative density function. To be specific, the reconfigurable circuitry 820 may compute the gamma transform function by:

T(l)=(lₘₐₓ−lₘᵢₙ)×2^{γ(log}^{₂}^{l-log}^{₂}^{(l}^{ₘₐₓ}^{-l}^{ₘᵢₙ}⁾⁾ (8),

where T(l) is the gamma transform function. γ could be represented by γ=1−CDF′ₛ(l)×P, where P is an adaptive parameter. The adaptive parameter P could be arbitrarily set as any number (e.g., 1) according to various design requirements.

The luminance transformation circuitry 830 may be coupled to the reconfigurable circuitry 820. In a fifth period after the fourth period, the luminance transformation circuitry 830 may generate a resulted image IM′ by adjusting a luminance distribution of the inputted image IM based on the gamma transform function. To be specific, the resulted luminance of the location (i,j) in the inputted image IM after the luminance distribution could be represented by:

Y={T(X(i,j)|∀X(i,j)εX} (9),

where Y is the resulted luminance of the location (i,j) in the inputted image IM X(i,j) is the luminance of the location (i,j) in the inputted image IM.

As could be observed in the equations (6), (7) and (8), the equations (6), (7) and (8) have similar forms and hence could be implemented by a single hardware module, instead of three individual hardware modules.

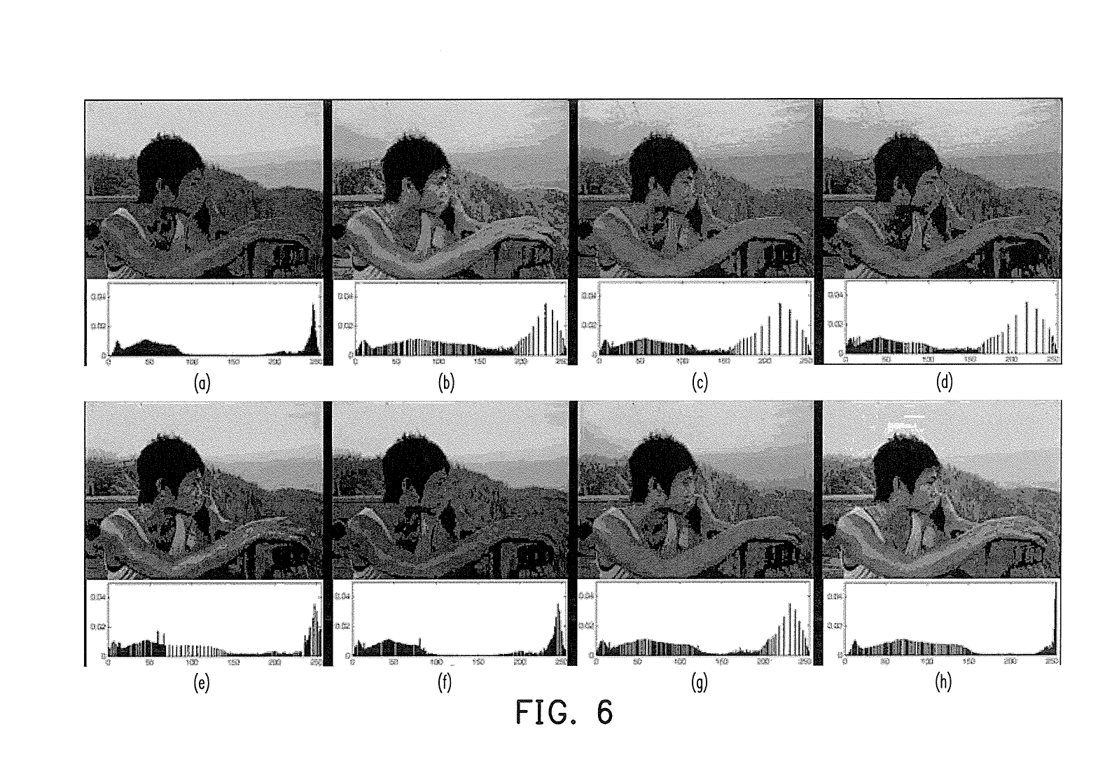

FIG. 9 is a schematic diagram illustrating the hardware design of the reconfigurable circuitry according to an exemplary embodiment of the present invention. In the present embodiment, the reconfigurable circuitry 820 includes a logarithmic calculation unit 910, a delay unit 920, a subtraction unit 930, a first multiplication unit 940, an exponent calculation unit 950 and a second multiplication unit 960.

The logarithmic calculation unit 910 may be configured to generate a first value V1 by performing a logarithmic calculating operation to a first input signal I1 (such as taking a logarithm on the first input signal I1 with base 2) at a first timing point of a specific period. Besides, the logarithmic calculation unit 910 may be configured to generate a second value V2 by performing the logarithmic calculating operation to a second input signal I2 (such as taking a logarithm on the second input signal I2 with base 2) at a second timing point of the specific period. The delay unit 920 may be coupled to the logarithmic calculation unit 910 and configured to receive the first value V1 and generate a delayed first value DV1 by delaying the first value V1.

The subtraction unit 930 may be coupled to the logarithmic calculation unit 910 and the delay unit 920. The subtraction unit 930 may be configured to subtract the second value V2 from the first value V1 to generate a third value V3 after receiving the first value V1 and the second value V2. The first multiplication unit 940 may be coupled to the subtraction unit 930 and configured to multiply the third value V3 with a first specific parameter SP1 to generate a fourth value V4. The exponent calculation unit 950 may be coupled to the first multiplication unit 940 and configured to generate a fifth value V5 by performing an exponent calculating operation to the fourth value V4 (e.g., the fifth value V5 may be computed by taking the fourth value V4 as the exponent of 2). The second multiplication unit 960 may be coupled to the exponent calculation unit 950 and configured to generate an output value OV by multiplying the fifth value V5 with a second specific parameter SP2.

With the hardware architecture illustrated in FIG. 9, the equations (6), (7) and (8) could be respectively computed with appropriately designed input signals and specific parameters.

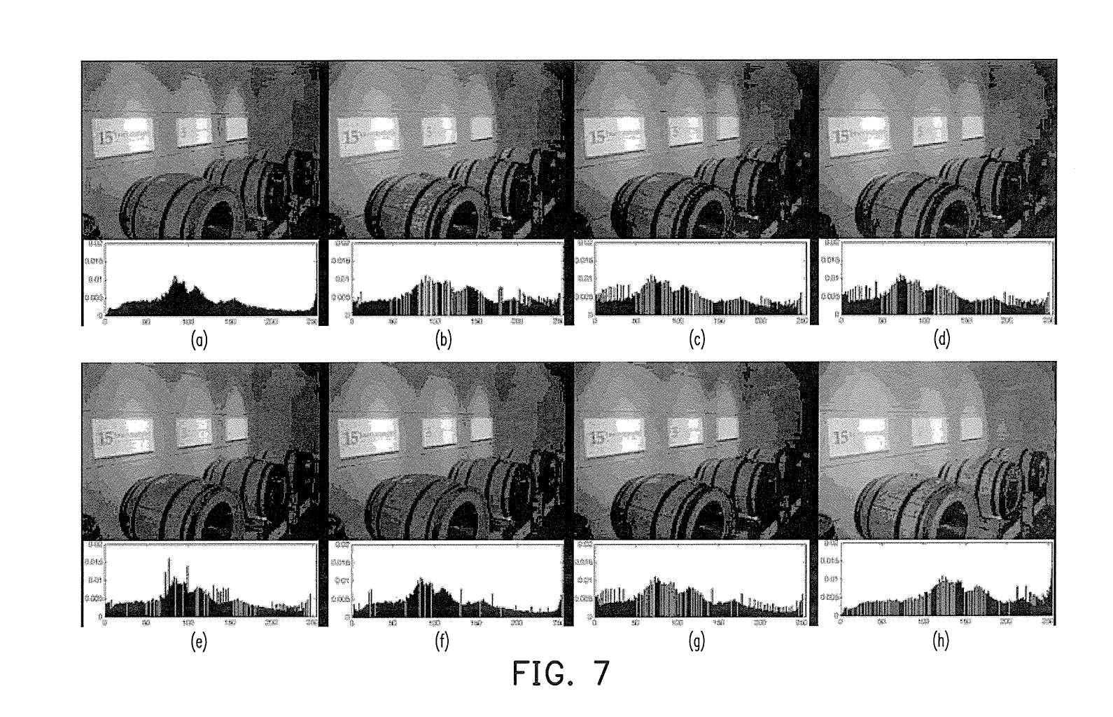

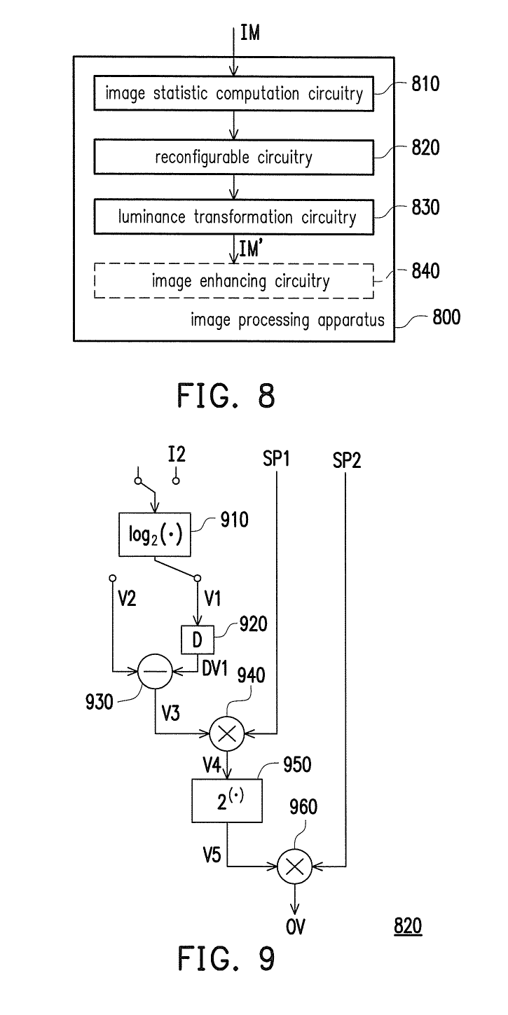

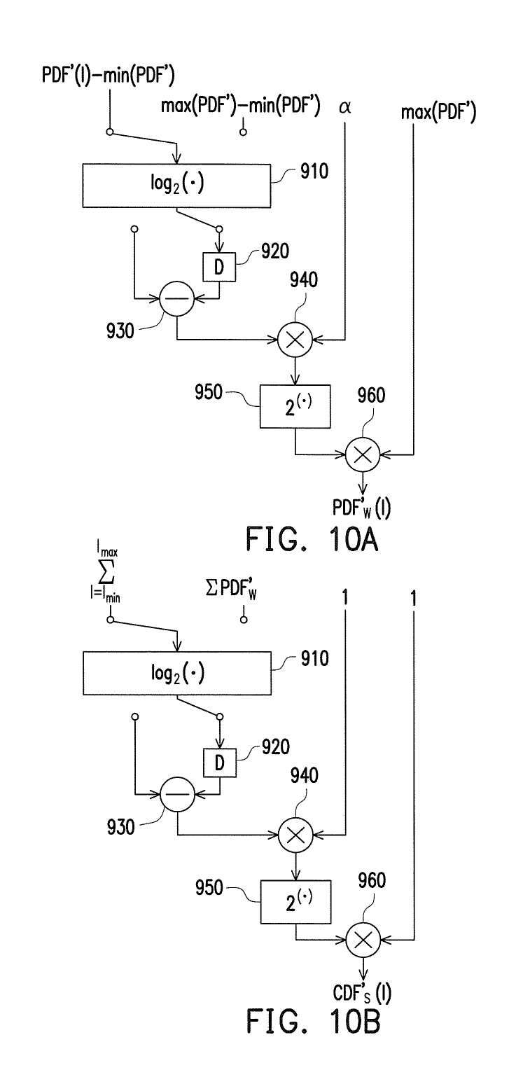

FIG. 10A is a schematic diagram illustrating the reconfigurable circuitry while computing the weighting distribution function in the second period according to an exemplary embodiment of the present invention. In the present embodiment, when the reconfigurable circuitry 820 is configured to compute the equation (6) in the second period, the first input signal I1 may be set as PDF′(l)−min(PDF′), the second input signal I2 may be set as max(PDF′)−min(PDF′), the first specific parameter SP1 may be set as the adaptive parameter α and the second specific parameter SP2 may be set as max(PDF′). Accordingly, the output value OV corresponding to the first input signal I1, second input signal I2, the first specific parameter SP1 and the second specific parameter SP2 would be obtained as PDF′_{w}(l).

FIG. 10B is a schematic diagram illustrating the reconfigurable circuitry while computing the smoothed cumulative density function in the third period according to an exemplary embodiment of the present invention. In the present embodiment, when the reconfigurable circuitry 820 is configured to compute the equation (7) in the third period, the first input signal I1 is Σₗ₌ₗ_{ₘᵢₙ}^{l}^{ₘₐₓ}PDF′_{ω}(l), the second input signal I2 is ΣPDF′_{w}, the first specific parameter SP1 is 1 and the second specific parameter SP2 is 1. Accordingly, the output value OV corresponding to the first input signal I1, second input signal I2, the first specific parameter SP1 and the second specific parameter SP2 would be obtained as CDF′ₛ(l).

FIG. 10C is a schematic diagram illustrating the reconfigurable circuitry while computing the gamma transform function in the fourth period according to an exemplary embodiment of the present invention. In the present embodiment, when the reconfigurable circuitry 820 is configured to compute the equation (8) in the fourth period, the first input signal I1 is 1, the second input signal I2 is lₘₐₓ−lₘᵢₙ, the first specific parameter SP1 is γ and the second specific parameter SP2 is lₘₐₓ−lₘᵢₙ. Accordingly, the output value OV corresponding to the first input signal I1, second input signal I2, the first specific parameter SP1 and the second specific parameter SP2 would be obtained as T(l).

In some embodiments, the logarithmic calculating operation performed by the logarithmic calculation unit 910 could be expressed as:

log₂h≈[(0.1519h−1.02123)h+3]h−2.13,hε[1,2) (10),

and the exponent calculating operation performed by the exponent calculation unit 950 could be expressed as:

2^{h}≅[(0.079h+0.2242)h+0.6967]h+0.999,hε[0,1) (11)

after lengthy mathematical derivations. Since the equations (10) and (11) have similar forms, the logarithmic calculation unit 910 and the exponent calculation unit 950 could be implemented by similar hardware architectures with appropriately designed parameters.

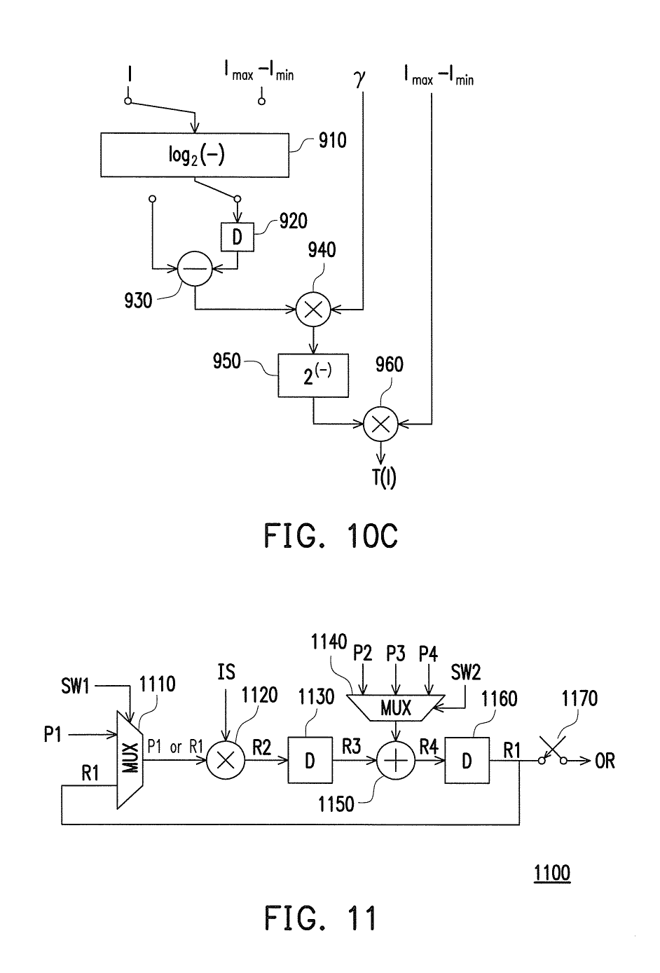

FIG. 11 is a schematic diagram illustrating a hardware architecture for implementing the logarithmic calculation unit and the exponent calculation unit. In the present embodiment, the hardware architecture 1100 includes a first multiplexer 1110, a multiplication unit 1120, a first delay unit 1130, a second multiplexer 1140, an adder 1150, a second delay unit 1160 and a switch 1170. The first multiplexer 1110 may be configured to sequentially output a first parameter P1 and a first result R1 in response to a first switch signal SW1. The multiplication unit 1120 may be coupled to the first multiplexer 1110 and configured to generate a second result R2 by multiplying an input signal IS with the first parameter P1 or the first result R1. The input signal IS may be the first input signal I1 or the second input signal I2. The first delay unit 1130 may be coupled to the multiplication unit 1120 and configured to generate a third result R3 by delaying the second result R2. The second multiplexer 1140 may be configured to sequentially output a second parameter P2, a third parameter P3 and a fourth parameter P4 in response to a second switch signal SW2. The adder 1150 may be coupled to the first delay unit 1130 and the second multiplexer 1140 and configured to generate a fourth result R4 by adding the third result R3 with the second parameter P2, the third parameter P3 or the fourth parameter P4. The second delay unit 1160 may be coupled to the adder 1150 and the first multiplexer 1110 and configured to generate the first result R1 by delaying the fourth result R4. The switch 1170 may be coupled to the second delay unit 1160 and configured to provide the first result R1 as an output result OR when the second multiplexer 1140 finishes outputting the second parameter P2, the third parameter P3 and the fourth parameter P4.

When the hardware architecture 1100 is adopted to implement the logarithmic calculation unit 910, the first parameter P1 may be set as 0.1519, the second parameter P2 may be set as −1.02123, the third parameter P3 may be set as 3 and the fourth parameter P4 may be set as −2.13. On the other hand, when the hardware architecture 1100 is adopted to implement the exponent calculation unit 950, the first parameter P1 may be set as 0.079, the second parameter P2 may be set as 0.2242, the third parameter P3 may be set as 0.6967 and the fourth parameter P4 may be set as 0.999.

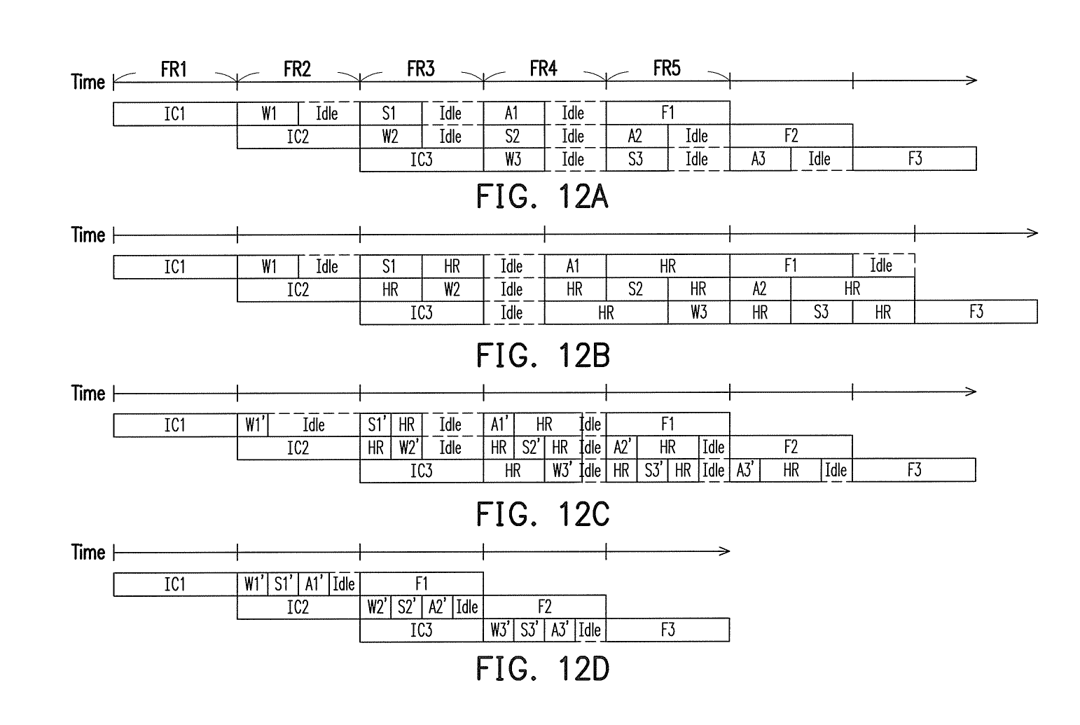

In some embodiments, the image processing apparatus 800 could be applied in a pipelined fashion to increase the image processing efficiency. FIG. 12A to FIG. 12D are schematic diagrams illustrating different results corresponding to various pipeline architectures. Detailed discussion would be provided below.

Traditionally, if the operations performed by the reconfigurable circuitry 820 are performed by three individual hardware modules, the resulted timing diagram of the pipeline mechanism would appear as illustrated in FIG. 12A. Referring to FIG. 12A, blocks IC1, W1, S1, A1 and F1 respectively represents the processing time for processing a first inputted image of the image statistic computation circuitry 810, the three individual hardware modules, and the luminance transformation circuitry 830. Blocks IC2, W2, S2, A2 and F2 respectively represents the processing time for processing a second inputted image (which is the image subsequent to the first inputted image) of the image statistic computation circuitry 810, the three individual hardware modules, and the luminance transformation circuitry 830. Blocks IC3, W3, S3, A3 and F3 respectively represents the processing time for processing a third image (which is the image subsequent to the second inputted image) of the image statistic computation circuitry 810, the three individual hardware modules, and the luminance transformation circuitry 830. As could be observed in FIG. 12A, when an inputted image is processed by the image statistic computation circuitry 810, the three individual hardware modules, and the luminance transformation circuitry 830, it needs five frames (i.e., frames FR1 to FR5) to finish the whole operation, and there obviously are lots of idle periods existing in FIG. 12A.

By adequately rearranging the blocks illustrated in FIG. 12A, as illustrated in FIG. 12B, it could be observed that there existing some hardware reconfigurable times HR could be used to perform some parallel processing.

Furthermore, by subsampling the blocks W1-W3, S1-S3, A1-A3, the blocks W1-W3, S1-S3, A1-A3 could be shortened to be blocks W1′-W3′, S1′-S3′, A1′-A3′ as illustrated in FIG. 12C.

By rearranging the blocks illustrated in FIG. 12C, as illustrated in FIG. 12D, it could be observed that the blocks W1′, S1′ and A1′ could be done in a single frame. However, the pipeline architecture of FIG. 12D could not be implemented by the image statistic computation circuitry 810, the three individual hardware modules, and the luminance transformation circuitry 830, but could be implemented by the image statistic computation circuitry 810, the reconfigurable circuitry 820 and the luminance transformation circuitry 830. In other words, with the proposed image processing apparatus 800, the processing time for processing an inputted image could be significantly reduced from five frames to three frames (i.e., the frames FR1-FR3), which makes the image processing apparatus 800 more suitable for real-time applications since the image processing apparatus 800 could achieve high image processing efficiency.

In some embodiments, the image processing apparatus 800 may further include an image enhancing circuitry 840. The image enhancing circuitry 840 may be coupled to the luminance transformation circuitry 830 and configured to enhance a definition of a specific pixel of the pixels included in the resulted image IM′ according to definitions of the pixels neighbouring to the specific pixel.

Specifically, the image enhancing circuitry 840 may compute a first image enhancing parameter by:

NPC(i,j)=Y(i,j)+Y(i−1,j)+Y(i,j−1)−Y(i−1,j−1) (12),

where (i,j) is a coordinate of the specific pixel in the resulted image IM′, NPC(i,j) is the first image enhancing parameter, Y(i,j) is the definition of the specific pixel. Next, the image enhancing circuitry 840 may compute a second image enhancing parameter by:

Sum(i,j)=NPC(i+a,j+a)−NPC(i−b,j+a)−NPC(i+a,j−b)+NPC(i−b,j−b) (13),

where Sum(i,j) is the second image enhancing parameter, a is a first shifting parameter and b is a second shifting parameter. Afterwards, the image enhancing circuitry 840 may compute a third image enhancing parameter by:

$$Avg ( i , j ) = \frac{Sum ( i , j )}{( 2 \times {Q}_{1} + 1 ) \times 2} , \qquad ( 14 )$$

where Avg(i,j) is the third image enhancing parameter, Q₁ is a first enhancing factor. Subsequently, the image enhancing circuitry 840 may compute an enhanced definition of the specific pixel by:

Y′(i,j)=Y(i,j)+(1+Q₂)×(Y(i,j)−Avg(i,j)) (15),

where Q₂ is a second enhancing factor. The first enhancing factor (Q₁) and the second enhancing factor (Q₂) could be arbitrarily set as any number according to various design requirements. By performing the calculation of the equations (12)-(15) to each of the pixels contained in the resulted image IM′, the image enhancing circuitry 840 may correspondingly enhance the definition of the whole resulted image IM′, such that the viewer may have a better visual experience.

To sum up, the embodiments of the present invention provide an image processing apparatus including a reconfigurable circuitry capable of sequentially compute the weighting distribution function, the smoothed cumulative density function and the gamma transform function with a shared hardware architecture. The proposed image processing apparatus could achieve a high image processing efficiency while providing great image quality, which makes the image processing apparatus more suitable for real-time applications. Besides, the definition of the resulted image outputted from the luminance transformation circuitry could be further enhanced through the proposed image enhancing circuitry, such that the image quality could be correspondingly increased.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An image processing apparatus, comprising:
an image statistic computation circuitry, configured to:
compute a probability density function corresponding to an inputted image;
generate a first luminance histogram by subsampling a luminance histogram related to the probability density function in a first period;
a reconfigurable circuitry, coupled to the image statistic computation circuitry, configured to:
compute a weighting distribution function according to the first luminance histogram in a second period after the first period;
compute a smoothed cumulative density function according to the weighting distribution function in a third period after the second period;
compute a gamma transform function in a fourth period after the third period, wherein the gamma transform function is related to the smoothed cumulative density function; and
a luminance transformation circuitry, coupled to the reconfigurable circuitry, configured to generate a resulted image by adjusting a luminance distribution of the inputted image based on the gamma transform function in a fifth period after the fourth period.

2. The image processing apparatus as claimed in claim 1, wherein the reconfigurable circuitry computes the weighting distribution function by:
PDF′_{ω}(l)=max(PDF′)×2^{β}
wherein β=α{log₂[PDF′(l)−min(PDF′)]−log₂[max(PDF′)−min(PDF′)]}
wherein/is a luminance of one of locations of the inputted image, PDF′_{ω}(l) is the weighting distribution function, PDF′(l) is the probability density function, max(PDF′) is a maximum probability density of the probability density function, min(PDF′) is a minimum probability density of the probability density function, and α is an adaptive parameter.

3. The image processing apparatus as claimed in claim 1, wherein the reconfigurable circuitry computes the weighting distribution function by:
$${CDF}_{s}^{′} ( l ) = {2}^{( {log}_{2} ( {Σ}_{l = {l}_{min}}^{{l}_{max}} {{PDF}_{ω}^{′} ( l )}^{′} ) - {log}_{2} ( Σ {PDF}_{ω}^{′} ) )}$$
wherein l is a luminance of one of locations of the inputted image, CDF′ₛ(l) is the smoothed cumulative density function, PDF′_{ω}(l) is the weighting distribution function, ΣPDF′_{w} is a sum of weighting probabilities, lₘₐₓ is a maximum luminance of the inputted image, and lₘᵢₙ is a minimum luminance of the inputted image.

4. The image processing apparatus as claimed in claim 1, wherein the reconfigurable circuitry computes the gamma transform function by:
T(l)=(lₘₐₓ−lₘᵢₙ)×2^{γ(log}^{₂}^{l-log}^{₂}^{(l}^{ₘₐₓ}^{-l}^{ₘᵢₙ}⁾⁾
wherein l is a luminance of one of locations of the inputted image, T(l) is the gamma transform function, lₘₐₓ is a maximum luminance of the inputted image and lₘᵢₙ is a minimum luminance of the inputted image,
wherein γ is represented by:
γ=1−CDF′ₛ(l)×P, wherein CDF′ₛ(l) is the weighting distribution function and P is an adaptive parameter.

5. The image processing apparatus as claimed in claim 1, wherein the reconfigurable circuitry comprises:
a logarithmic calculation unit, configured to:
generate a first value by performing a logarithmic calculating operation to a first input signal at a first timing point of a specific period;
generate a second value by performing the logarithmic calculating operation to a second input signal at a second timing point of the specific period;
a delay unit, coupled to the logarithmic calculation unit, configured to receive the first value and generate a delayed first value by delaying the first value;
a subtraction unit, coupled to the logarithmic calculation unit and the delay unit, configured to subtract the second value from the first value to generate a third value after receiving the first value and the second value;
a first multiplication unit, coupled to the subtraction unit, configured to multiply the third value with a first specific parameter to generate a fourth value;
an exponent calculation unit, coupled to the first multiplication unit, configured to generate a fifth value by performing an exponent calculating operation to the fourth value; and
a second multiplication unit, coupled to the exponent calculation unit, configured to generate an output value by multiplying the fifth value with a second specific parameter.

6. The image processing apparatus as claimed in claim 5, wherein when the specific period is the second period, the first input signal is PDF′(l)−min(PDF′), the second input signal is max(PDF′)−min(PDF′), the first specific parameter is an adaptive parameter, the second specific parameter is max(PDF′), and the output value is PDF′_{w}(l),
wherein l is a luminance of one of locations of the inputted image, PDF′_{ω}(l) is the weighting distribution function, PDF′(l) is the probability density function, max(PDF′) is a maximum probability density of the probability density function and min(PDF′) is a minimum probability density of the probability density function.

7. The image processing apparatus as claimed in claim 5, wherein when the specific period is the third period, the first input signal is Σₗ₌ₗ_{ₘᵢₙ}^{l}^{ₘₐₓ}PDF′_{ω}(l), the second input signal is ΣPDF′_{w}, the first specific parameter is 1, the second specific parameter is 1, and the output value is CDF′ₛ(l),
wherein l is a luminance of one of locations of the inputted image, CDF′ₛ(l) is the smoothed cumulative density function, PDF′_{ω}(l) is the weighting distribution function, ΣPDF′_{w} is a sum of weighting probabilities, lₘₐₓ is a maximum luminance of the inputted image, and lₘᵢₙ is a minimum luminance of the inputted image.

8. The image processing apparatus as claimed in claim 5, wherein when the specific period is the fourth period, the first input signal is l, the second input signal is lₘₐₓ−lₘᵢₙ, the first specific parameter is γ, the second specific parameter is lₘₐₓ−lₘᵢₙ, and the output value is T(l),
wherein 1 is a luminance of one of locations of the inputted image, T(l) is the gamma transform function, lₘₐₓ is a maximum luminance of the inputted image and lₘᵢₙ is a minimum luminance of the inputted image,
wherein γ is represented by:
γ=1−CDF′ₛ(1)×P, wherein CDF″ₛ(l) is the weighting distribution function and P is an adaptive parameter.

9. The image processing apparatus as claimed in claim 5, wherein the logarithmic calculation unit comprises:
a first multiplexer, configured to sequentially output a first parameter and a first result in response to a first switch signal;
a multiplication unit, coupled to the first multiplexer, configured to generate a second result by multiplying an input signal with the first parameter or the first result, wherein the input signal is the first input signal or the second input signal;
a first delay unit, coupled to the multiplication unit, configured to generate a third result by delaying the second result;
a second multiplexer, configured to sequentially output a second parameter, a third parameter and a fourth parameter in response to a second switch signal;
an adder, coupled to the first delay unit and the second multiplexer, configured to generate a fourth result by adding the third result with the second parameter, the third parameter or the fourth parameter;
a second delay unit, coupled to the adder and the first multiplexer, generating the first result by delaying the fourth result; and
a switch coupled to the second delay unit, configured to provide the first result as an output result when the second multiplexer finishes outputting the second parameter, the third parameter and the fourth parameter.

10. The image processing apparatus as claimed in claim 9, wherein the first parameter is 0.1519, the second parameter is −1.02123, the third parameter is 3 and the fourth parameter is −2.13.

11. The image processing apparatus as claimed in claim 5, wherein the exponent calculation unit comprises:
a first multiplexer, configured to sequentially output a first parameter and a first result in response to a first switch signal;
a multiplication unit, coupled to the first multiplexer, configured to generate a second result by multiplying an input signal with the first parameter or the first result, wherein the input signal is the first input signal or the second input signal;
a first delay unit, coupled to the multiplication unit, configured to generate a third result by delaying the second result;
a second multiplexer, configured to sequentially output a second parameter, a third parameter and a fourth parameter in response to a second switch signal;
an adder, coupled to the first delay unit and the second multiplexer, configured to generate a fourth result by adding the third result with the second parameter, the third parameter or the fourth parameter;
a second delay unit, coupled to the adder and the first multiplexer, generating the first result by delaying the fourth result; and
a switch coupled to the second delay unit, configured to provide the first result as an output result when the second multiplexer finishes outputting the second parameter, the third parameter and the fourth parameter.

12. The image processing apparatus as claimed in claim 11, wherein the first parameter is 0.079, the second parameter is 0.2242, the third parameter is 0.6967 and the fourth parameter is 0.999.

13. The image processing apparatus as claimed in claim 1, wherein the resulted image comprises a plurality of pixels, and the image processing apparatus further comprising an image enhancing circuitry, coupled to the luminance transformation circuitry, configured to enhance a definition of a specific pixel of the pixels according to definitions of the pixels neighbouring to the specific pixel.

14. The image processing apparatus as claimed in claim 13, wherein the image enhancing circuitry is configured to:
compute a first image enhancing parameter by:
NPC(i,j)=Y(i,j)+Y(i−1,j)+Y(i,j−1)−Y(i−1,j−1),
wherein (i,j) is a coordinate of the specific pixel in the resulted image, NPC(i,j) is the first image enhancing parameter, Y(i,j) is the definition of the specific pixel;
compute a second image enhancing parameter by:
Sum(i,j)=NPC(i+a,j+a)−NPC(i−b,j+a)−NPC(i+a,j−b)+NPC(i−b,j−b),
wherein Sum(i,j) is the second image enhancing parameter, a is a first shifting parameter and b is a second shifting parameter;
compute a third image enhancing parameter by:
$$Avg ( i , j ) = \frac{Sum ( i , j )}{( 2 \times {Q}_{1} + 1 ) \times 2} ,$$
wherein Avg(i,j) is the third image enhancing parameter, Q₁ is a first enhancing factor; and
compute an enhanced definition of the specific pixel by:
Y′(i,j)=Y(i,j)+(1+Q₂)×(Y(i,j)−Avg(i,j)),
wherein Q₂ is a second enhancing factor.
